(19) United States
(12) Patent Application Publication
(10) Pub. No.: US 2019/0187824 A1
(43) Pub. Date: Jun. 20, 2019

(54) INPUT SYSTEM

(71) Applicant: STAEDTLER MARS GMBH & CO. KG, Nürnberg (DE)

(72) Inventors: Axel MARX, Schwarzenbruck-Lindelburg (DE); Ernst BADER, Geiselwind (DE); Konstantin CZESCHKA, Buckenhof (DE); Alexander VYHNAL, Nürnberg (DE); Hans-Peter SIMON, Erlangen (DE)

(21) Appl. No.: 16/328,097

(22) PCT Filed: Aug. 2, 2017
(86) PCT No.: PCT/EP2017/000936

§ 371 Date: Feb. 25, 2019

(30) Foreign Application Priority Data
Aug. 25, 2016 (DE) 102016010528.3

(51) Int. Cl. G06F 3/0354; G06F 3/046; G06F 3/044; B43K 21/00; B43K 7/00; B43K 29/08; B43K 8/20; B42D 1/00; B42F 13/16; B42D 5/00

(52) U.S. Cl. CPC G06F 3/03545; G06F 3/046; G06F 3/044; B43K 21/00; B43K 7/00; B42P 2241/16; B43K 8/20; B42D 1/007; B42F 13/16; B42D 5/003; B43K 29/08

(57) ABSTRACT

An input system having at least one sensor board, at least one recording medium and at least one input device/stylus. The at least one sensor board is divided into at least two virtual sub-boards or the at least one sensor board is in the form of two separate sensor boards. The two sensor boards have, on at least one side edge, a structure for mutual fixing. A multi-page recording medium is arranged over the at least one sensor board. The at least one input device/stylus has an analogue application function. The at least one input device/stylus has a digital input function/signal function for sensor boards.

The invention relates to an input system according to the preamble of claim 1.

Input systems for creating analog and digital recordings are known in principle.

For example, input systems in which characters, hand-drawn sketches and the like are drawn onto the surface of a tablet/display using a hand-guided stylus in order to then be transmitted in some form to a computer system for storage and/or further processing are known. The stylus used for this purpose does not dispense any application medium in the use described.

The disadvantage can be seen here in the fact that the recording is present only in digital or electronic form.

Another system available on the market now makes it possible, in addition to a digital recording, to simultaneously also create an analog or physical recording. For this purpose, the stylus is provided with a refill which dispenses a recording medium which records the information on a medium in an analog manner, but simultaneously enables a digital recording via electromagnetic pulses or capacitive changes on the display.

The disadvantage can be seen here in the fact that the recording media in the form of individual sheets are positioned in front of the display. Individual sheets provided with recordings which are generally forgotten in a disorganized manner are therefore produced. In addition, individual sheets are written on or used only on one side in this manner.

Organizers/calendars or spiral-bound notebooks are written on by hand in order to store an overview of appointments and contents from meetings in an organized form.

The disadvantage here is that it is necessary to manually search through many paper records in order to have recourse to noted situations, even after years. Storing older record books and ring binders also takes up space.

The object of the invention is therefore to provide an input system which does not have the disadvantages mentioned at the outset and reliably ensures both digital recording and analog recording on normal paper.

Furthermore, the intention is to enable double-sided analog inscription of the recording medium in a simple manner without any problems.

The object of the invention is also for the recording medium to be present as continuous recordings with the input system.

This object is achieved with the features according to claim 1 and claim 8.

The input system according to the invention consists of at least one sensor board, at least one recording medium and at least one input device/stylus.

The at least one sensor board is either divided into at least two virtual sub-boards or is in the form of two separate sensor boards, wherein the at least two separate sensor boards have means for mutual fixing on at least one lateral edge.

In this case, it is possible to connect the at feast two sensor boards to one another in an articulated manner. Alternatively, the at least two sensor boards are in the form of separate parts which, at the time of input or use, are brought into contact with one another on a lateral edge, wherein means for mutual fixing in a manner secured against displacement are fitted to the sides.

A sensor board should be understood as meaning action or input surfaces which have an electromagnetic field. If an input device/stylus having a coil approaches these surfaces with a formed electromagnetic field, the electromagnetic field of the surface is disrupted. The resulting disruption points are captured as positions, input points or defined points (X, Y) on the surface.

In this manner, writing and drawing movements carried out in an analog manner using an input device/stylus having a coil, for example, can be digitally captured by the sensor board.

At least one multi-page recording medium which is in the form of a spiral pad, a ring binder, a folder, a bound notebook, a bound book, a multi-page calendar and/or a tear-off pad is arranged above or on the surface/input surface of the sensor board.

Characters or graphics of any kind can be applied to the recording medium using at least one input device/stylus by means of an analog application function. In addition to this analog recording, a digital input using a digital input function/signal function is simultaneously effected on the sensor board using the at least one input device/stylus irrespective of whether the recording medium arranged above the sensor board has a multi-page design.

The analog application function is implemented and designed using a writing unit held in the input device, wherein the writing unit is in the form of a fixed refill/solid lead, a cartridge/refill with paste and/or a cartridge/refill filled with ink.

A lead pencil or color pencil leads are mentioned by way of example for fixed refills. Refills with pastes may be in the form of conventional ball pen refills or, in the case of ink, in the form of a so-called rollerball pen.

The important factor in this case is that the recording medium is held on the at least one sensor board in a manner secured against displacement when creating analog recordings using the input device/stylus. For this purpose, means such as clamps, stops and/or hard surfaces must be formed on the sensor board in order to ensure that the recording medium is held in a manner secured against displacement.

At the same time as the analog recording on the recording medium, a digital input function or signal capture corresponding to the analog recording therefore takes place on the sensor board. This means that digital recordings/signals and analog recordings are identically captured at the same time and this is carried out not only on one side but also on both sides of the at least one recording medium.

Since the recording medium is a multi-page system, for example a bound notebook, both the front side and the reverse side can be used for the recording by turning the page. As conventionally learnt, the result is therefore a bound notebook with analog content and a continuous digital book in stored form. The advantage here can be seen in the fact that paper is saved on account of the double-sided use and it is possible to dispense with the handling, including the archiving, of individual sheets.

In order to enable or produce a digital recording in book form, an input option on the sensor board is used to indicate to the processing system that a page has been changed and/or turned. Such input options are the prior art and shall not be described in any more detail below.

Said digital input function is effected using at least one input device/stylus, for example a stylus operating on the basis of so-called electro-magnetic resonance technology (EMR technology) or active electrostatic technology (AES technology). The communication between the stylus and the sensor board is therefore designed as EMR technology or as AES technology.

When using these two known technologies or other input technologies, it has been found that digital input/signal capture is also carried out on the sensor board when a plurality of sheets/pages of the recording medium are arranged above one another on the sensor board.

The sensor boards are connected to smart devices, for example computers, tablet computers, notebooks and/or smartphones, in any form according to the known prior art for the purpose of transmitting the digital recording. In this case, the data can be transmitted by cable and/or in a wireless manner.

In the input system according to the invention, it can be considered to be particularly advantageous that the recording medium is in the form of normal paper. The advantage in this case is that there is no need to use expensive special paper, for example so-called dot paper with a “type” of coordinate system printed on.

Alternatively, the at least one sensor board may be in the form of at least one capacitive touch-sensitive display, not like described above. In this embodiment, a digital input can be effected on the display using a stylus and its use according to DE 10 2012 010 966. If a recording medium is now introduced between the display and the stylus tip, an analog recording on the recording medium and digital capture on the capacitive touch-sensitive display are likewise effected at the same time. In this embodiment, the at least one display may be an element of so-called smart devices.

The invention shall be explained further below using FIGS. 1 to 4,

FIG. 1: two independently operating sensor boards for an input system according to the invention;

FIG. 2: input system having sensor boards according to FIG. 1 and an inserted exercise book;

FIG. 3: input system according to the invention in accordance with FIG. 2 in the folded-up state;

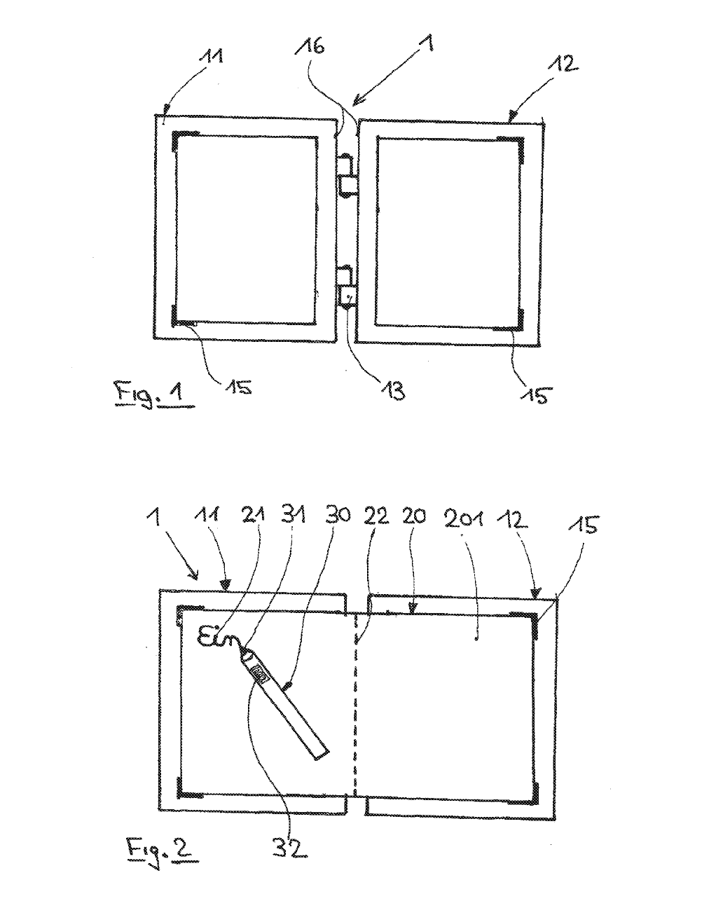

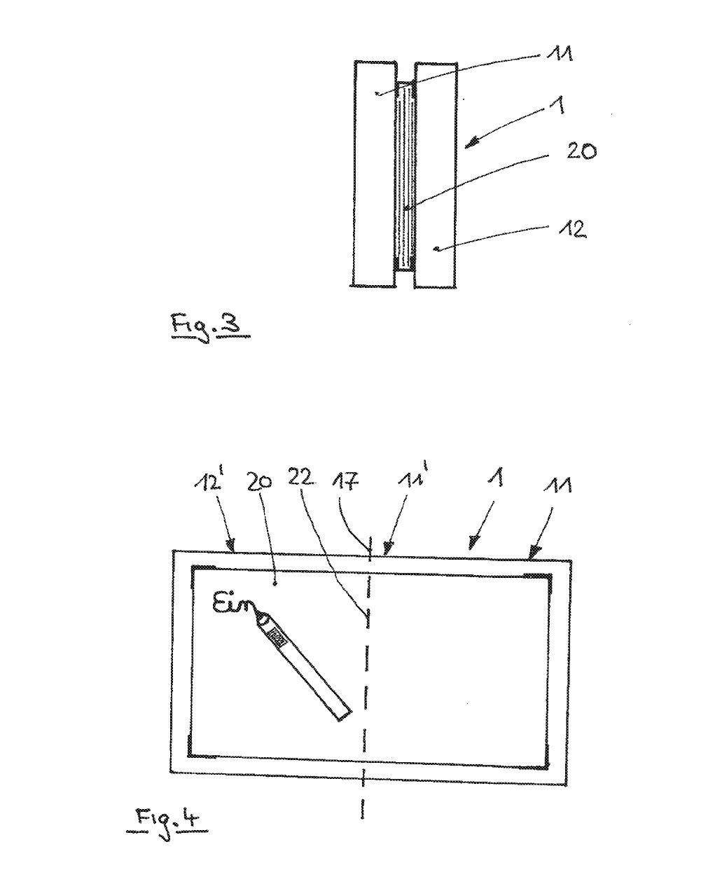

FIG. 4: alternative embodiment of an input system having a virtually divided sensor board.

FIG. 1 shows a sensor board 11 and a sensor board 12 of an input system 1 according to the invention, wherein the sensor boards 11 and 12 are connected in an articulated manner by means of two connecting elements 13 arranged on the lateral edges 16. The sensor boards 11 and 12 are therefore held in a manner secured against displacement with respect to one another. Fixing devices 15 which likewise provide holding in a manner secured against displacement when the recording medium (20) is arranged above the sensor board 11 and 12 during use are situated on each of the sensor boards. In the present embodiment, the sensor boards can be folded up like a book via the articulated connection 13, as a result of which the sensor boards 11 and 12 are additionally reliably protected during transport.

The connecting elements between the sensor boards can alternatively also be in the form of a plug-in system, a film hinge, a rubber-elastic connection and/or an adhesive system.

FIG. 2 shows an input system 1 according to the invention consisting of a board arrangement 11 and 12 according to FIG. 1 and a recording medium 20 which is inserted or applied over the boards 11 and 12 and is held or fixed in a manner secured against displacement via the fixing devices 15.

An input device/stylus 30 having a writing unit 31 can be used to make analog recordings 21 on the recording medium 20 using the writing unit 31. In this case, it is insignificant whether the recordings are made on the left-hand or right-hand page/sheet 201, separated by the bending or union line 22 of the notebook 20.

The analog recordings 21 are now simultaneously transmitted to the sensor board 11, 12 under the corresponding recording medium 20 via EMR technology with a coil 32 which is likewise integrated in the input device/stylus 30. In this case, it should be noted that the technology and power of the input devices 30, in combination with high-resolution or highly sensitive sensor boards 11 and 12, are so advanced that the recording medium 20 can have a plurality of pages/sheets 201 above one another in order to simultaneously capture an analog recording 21 as a digital recording/signal (14) in the sensor board 11, 12.

The advantage of the input system according to the invention takes effect here, according to which—like prior art until now—sheets in notebooks can be inscribed in an analog manner on both sides and these analog inscriptions can simultaneously also be digitally stored or captured without sheets having to be turned and newly positioned on the boards in order to also have to be organized or stapled and stored at a later time.

In this case, it is necessary to state that the sensor board must receive only an input command—prior art—if the recording medium is turned over so that the digital storage file recognizes and accordingly stores the book form. This reliably prevents the situation in which, although though new pages are always written on in an analog manner, all recordings are digitally placed on one page.

It has emerged in a particularly advantageous manner that, if the input system 1 is temporarily not used, the sensor boards 11 and 12 with the inserted recording medium 20 can be folded up. This provides a very tidy and organized system 1 which is ready for operation again within seconds for further analog and digital recordings (21, 14). The folded-up state of the system 1 can be gathered from FIG. 3.

An embodiment in which the book covers of the recording medium are in the form of sensor boards is not illustrated.

FIG. 4 shows and describes an alternative embodiment of the input system 1 according to the invention. In this embodiment, use is made of only one sensor board 11 which, however, can be virtually divided into two board halves 11′ and 12′ using programming. In this embodiment, a multi-page recording medium 20 is fixed above the board halves 11′ and 12′. The structure is then comparable, in principle, to the functional system according to FIG. 2.

The virtual dividing line 17 between the board halves 11′ and 12′ is advantageously equal to the bending or union line 22 of the recording medium 20.

### ITEM LIST

1 Input system

11 Sensor board 1

12 Sensor board 2

13 Connecting element

14 Digital recording/digital swab

15 Fixing device

16 Lateral edge

17 Virtual dividing line

20 Recording medium

201 Page/sheet

21 Analog recording

22 Bending or union line

30 Input device/stylus

31 Writing unit

32 Coil

1-8. (canceled)

9. An input system, comprising: at least one sensor board; at least one recording medium; and at least one input device/stylus, wherein the at least one sensor board is divided into at least two virtual sub-boards or the at least one sensor board is two separate sensor boards, wherein the two sensor boards have means for mutual fixing on at least one lateral edge, wherein a multi-page recording medium is arranged above the at least one sensor board, wherein the at least one input device/stylus has an analog application function, and wherein the at least one input device/stylus has a digital input function/signal function for sensor boards.

10. The system according to claim 9, wherein the analog application function is implemented and designed using a writing unit held in the input device, wherein the writing unit is a solid lead, a cartridge with paste and/or a cartridge filled with ink.

11. The system according to claim 9, wherein the input device/stylus is configured to input the digital input function/signal function.

12. The system according to claim 9, wherein communication between the stylus and the sensor board is designed as EMR technology, or the communication between the stylus and the sensor board is designed as AES technology.

13. The system according to claim 9, wherein digital recordings are forwarded from the at least one sensor board to a smart device, wherein the smart device is a computer, tablet computer or smartphone.

14. The system according to claim 9, wherein the multi-page recording medium is at least one of the group consisting of: a spiral pad, a ring binder, a bound notebook, a bound book, a multi-page calendar and a tear-off pad.

15. The system according to claim 9, wherein the at least one sensor board has means for holding the recording medium in a manner secured against displacement.

16. The system according to claim 9, wherein the recording medium is paper.
